(19) United States
(12) Patent Application Publication
(10) Pub. No.: US 2011/0194135 A1
(43) Pub. Date: Aug. 11, 2011

(54) Print View With Easy Page Removal

(76) Inventors: Hayden Hamilton, Portland, OR (US); James Kellerman, Portland, OR (US); Siva Praveen Mummaneni, Vijayawada (IN)

(21) Appl. No.: 12/845,622

(22) Filed: Jul. 28, 2010

Related U.S. Application Data
(63) Continuation-in-part of application No. 11/499,235, filed on Aug. 3, 2006, now abandoned.

(51) Int. Cl. G06K 15/02; G06F 3/12

(52) U.S. Cl. 358/1.14; 358/1.15

(57) ABSTRACT

A computer readable medium having a computer program which when installed on a computer having applications which can be commanded to print and which place pages in a print queue, causes a print command to result in a display of pages and which permits a user to remove any of said displayed pages from said print queue by a sequence of mouse clicks.

### RELATED APPLICATIONS

This application is a continuation in part of application Ser. No. 11/499,235 filed Aug. 3, 2006, which is incorporated by reference as if fully set forth herein.

### BACKGROUND

Currently print jobs from a workstation sent to a single printer either directly or through a network, need to be manually configured to avoid the wastage of paper and ink. Manually configuring these print jobs typically involves identifying and removing blank pages and pages that have only wasteful information on them such as a banner advertisement, header, footer or page number. This task is hindered by the shortcomings of print preview screens now available. Typically, one must scroll through a set of pages displayed at full size, and then remember to not choose the pages that do not have useful information on them, to be printed.

Increasing paper and ink costs, as well as a consciousness of sustainability, have made the waste problem more important. Moreover, these printing costs have remained untraceable with no current systems for tracking the expense of paper and ink waste.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

In a first separate aspect, the present invention may take the form of computer readable medium having a computer program that when installed on a computer having applications which can be commanded to print and which place pages in a print queue, causes a print command to result in a display of pages and which permits a user to remove any of the displayed pages from the print queue by a sequence of mouse clicks.

In a second separate aspect, the present invention may take the form of computer readable medium having a computer program that when installed on a computer having applications which in response to a command to print places pages in a print queue, causes a print command to result in a display of pages, the pages displayed at a user adjustable page display size.

In a third separate aspect, the present invention may take the form of a computer, comprising computer readable media having computer programs which can be user commanded to cause a print queue to be sent to a printer. Also, computer readable media has a computer program that when a user commands a print queue be sent to a printer, causes a display of pages in the print queue and permitting a user to remove a page from the print queue by a sequence of mouse clicks.

In addition to the exemplary aspects and embodiments described above, further aspects and embodiments will become apparent by reference to the drawings and by study of the following detailed descriptions.

### BRIEF DESCRIPTION OF THE DRAWINGS

FIG. 1 is a block diagram overview of the invention's preferred embodiment where a logic process system and method reduce printer expenses on paper and ink usage.

FIG. 2 through FIG. 9 represent a continuous flow chart indicating the preferred embodiment of the invention system and the method for reducing expenses on paper and ink usage.

FIG. 10 is a block diagram illustrating a preferred embodiment of the present invention.

FIG. 11 is a block diagram illustrating an alternative preferred embodiment of the present invention.

FIG. 12 is a block diagram illustrating a further preferred embodiment of the present invention.

FIG. 13 is a block diagram illustrating a further preferred embodiment of the present invention.

FIG. 14 is a block diagram illustrating a generalized implementation of a preferred embodiment of the present invention.

FIG. 15 is a representation of a computer screen display created by a preferred embodiment of the present invention, in response to a print command for a six page document.

FIG. 16 is a representation of a computer screen display created by a preferred embodiment of the present invention, in response a right click on a display for a two page document, but otherwise the same as that for FIG. 15.

FIG. 17 is a representation of a computer screen display created by a preferred embodiment of the present invention, in response to a print command for an 18 page document, followed by a right click on a page being displayed.

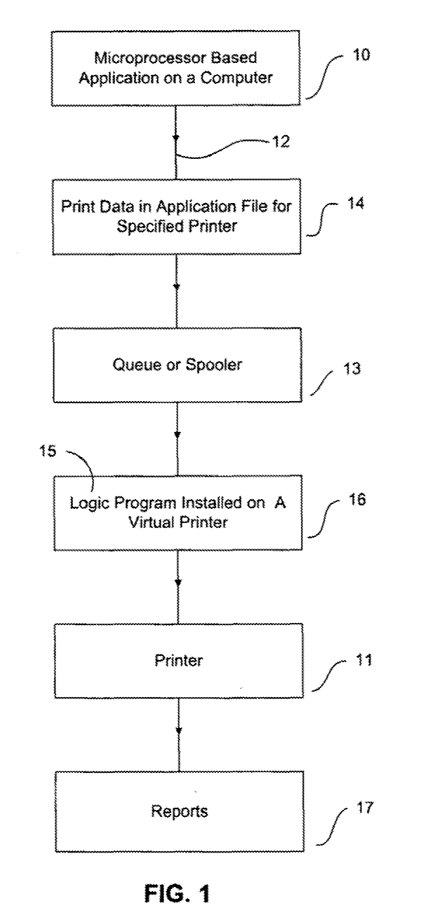

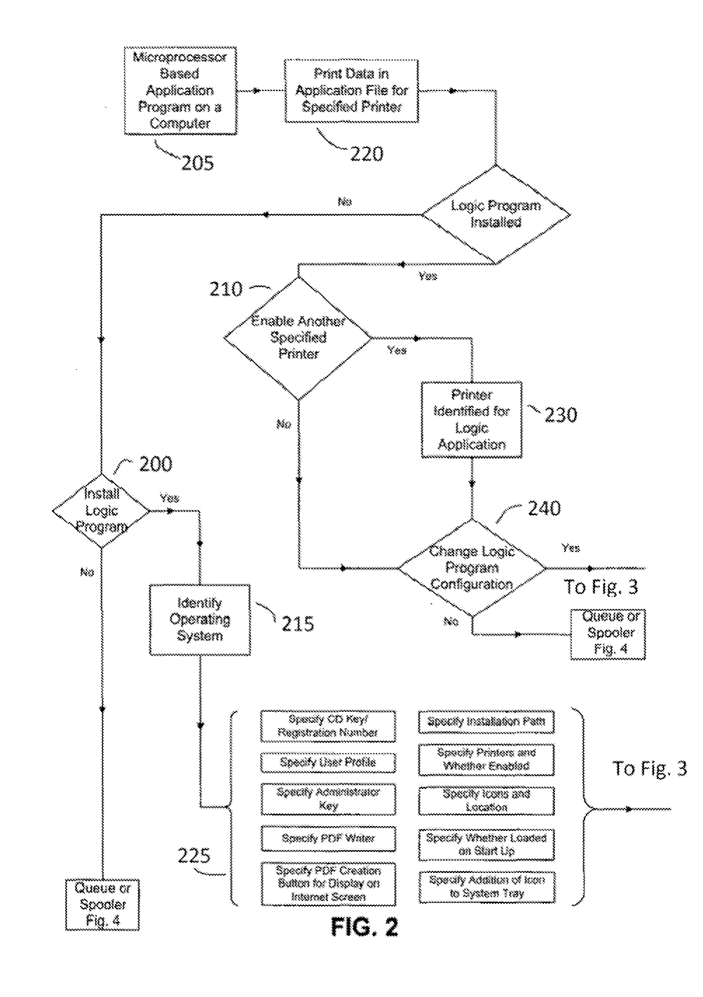

Exemplary embodiments are illustrated in referenced drawings. It is intended that the embodiments and figures disclosed herein are to be considered illustrative rather than restrictive.

### DETAILED DESCRIPTION OF THE PREFERRED EMBODIMENTS

One preferred embodiment of the invention relates generally to a method and a system for reducing printing expenses. More specifically, a preferred embodiment is a method that uses specially designed software to reduce paper usage and reduce ink usage. The software may be installed on a system containing one or more computers, and one or more printers. In one mode the software operates on a single computer and a single printer. In another mode, the software operates on a network of computers controlling a number of associated printers.

In either mode, the software may be used when a print message 10 is generated by an application program. The message will contain a print job formatted pursuant to the application program's rules. In the current normal course, the print is converted to a common format (CF) file 11, such as an Enhanced Meta File (EMF). A print job translated to a CF file typically may be accepted as input by all printer drivers.

When the specially designed software is installed 12 on a computer, and the user has commanded the software to process the print job, the software will divert the CF file of the print job for an analysis 13. The analysis may be performed on a virtual printer 14. A virtual printer is seen by the computer in the same manner it would see a real printer. During the software analysis of the print job, the software makes a tentative determination of the pages to be printed and the pages to be eliminated for optimum use of paper and printer ink.

The software analysis is performed pursuant to user selected criteria, selected when the user configures 15 the software. Criteria may include determining whether a prospective page for printing has only a header & footer, or has less than x lines of text, has only images, or is more than x % blank area The criteria are user configurable.

In a preferred embodiment, following the software analysis, a user has the option to preview 16 all pages analyzed by the software, or a user may preview only pages marked for removal by the software analysis. During the preview, a user may change any page status from remove to print.

Expenses saved through identification of waste pages will be gathered statistically by the software. Reports tracking 17 these statistics are available at the user's or the administrator's option. In a preferred embodiment, a user may choose the amount of detail provided for each report and may also determine whether the reports are provided automatically at specified time intervals or whether the reports are generated anytime at the user's discretion. Reports can provide a user with a greater understanding of printing habits and potential saving opportunities either individually or for the entire network.

In greater detail the software operates on a system containing at least a computer and a printer. A print job 220 requested by a user of this system will trigger the execution of the software to perform tentative waste page identification, provided two primary events have taken place. The first event is installation 200 of the software. The second event is enablement 210 of an installed printer in the system. Identification of the installed printers is automatically performed by the software upon installation.

The software is designed to be installed on a broad range of operating systems 205 including MAC OSX and Windows versions XP, Vista, and 7. Identification of the operating system is automatically performed by the software 215. During installation, several user actions and choices are prompted by the software (block 225). The actions can include inputting a license key or registration number and indicating whether the person installing the software is a user or an administrator. A user is given access to reports for all of the user's print jobs. Input of a user profile is also prompted. In a preferred embodiment, the user also chooses, the path for the software's installation, the printers to be enabled, whether a desktop icon and/or a task bar icon is to be created, and whether the software is loaded automatically on start up. In an alternative preferred embodiment there is no selection of “user” or administrator during the process by which the software is installed on an individual user computer. In server-based networked systems, however, network administrators, who have rights to log on to the server, have a broader range of available actions, as will be described further below.

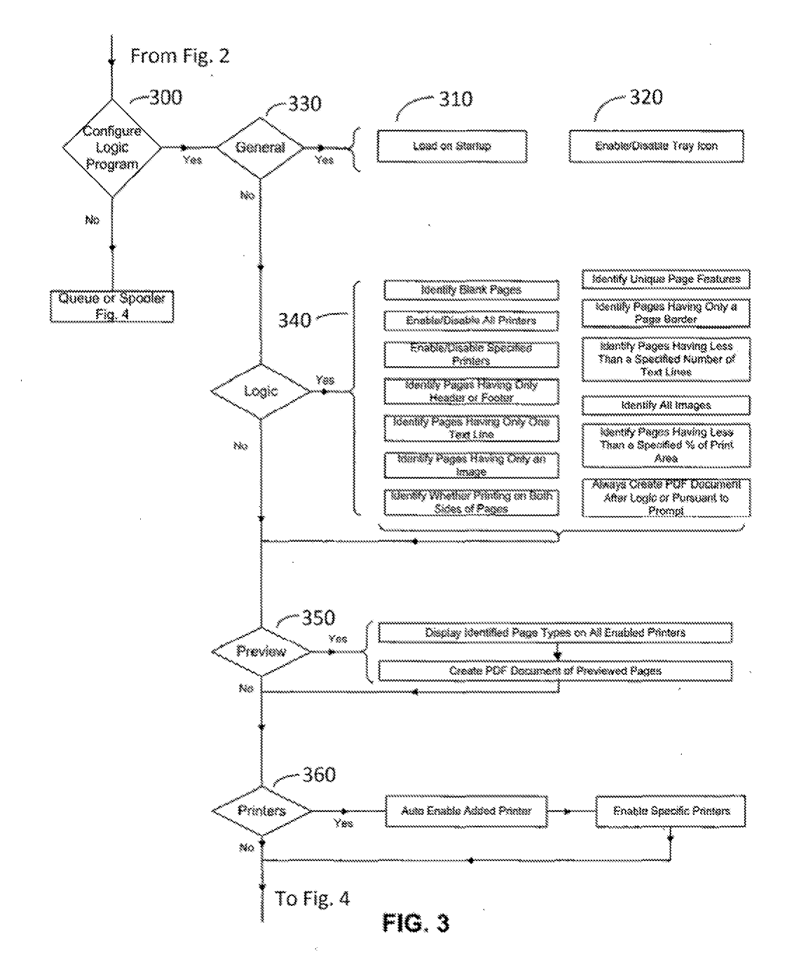

In a preferred embodiment, when installation has been completed, the user must configure 300 (FIG. 3) the software programs by choosing from an options display that may be accessed from an application start menu or from a tray icon. The options display is divided into groups with the first group being the general options 330.

In the general configuration options, the installer specifies whether the software is to load automatically 310 on start up or whether it will load only pursuant to a screen prompt, and whether the software's tray icon 320 is to be enabled or disabled.

The next set of configuration options configures the software's logic capabilities 340. Here, in one preferred embodiment, the user specifies, as listed on the drawings 340:
whether the software is enabled on all printers or disabled on all printers,
whether the software is enabled only on specific printers,
whether completely blank pages should be identified for removal from the print job,
whether pages having only one line of text should be identified for removal from the print job,
whether pages having only a header and/or footer should be identified for removal from the print job,
whether pages having only images should be identified for removal from the print job,
whether pages having only a border should be identified for removal from the print job,
whether both sides of pages should have printing,
whether pages having less than a specified number of text lines should be identified for removal from the print job,
whether pages having a specified percentage of blank space should be identified for removal from the print job,
whether each image should be identified for preview,
whether PDF documents will automatically be created after application of the software's logic or whether the user must activate a prompt from each view screen to create PDF documents of the print job, and
whether any user indicated unique page characteristics or user indicated unique page information should be identified for removal from the print job.

For the next configuration option (in a preferred embodiment), the installer chooses, for each enabled printer, whether pages identified by the configured software should be displayed. The display allows a user to preview 350 print job pages identified by the software. During this page preview, the user may modify the software's determination whether the page or image should be printed or deleted.

In a preferred embodiment, printer configuration 360 is the next choice during configuration of the software. A newly installed printer can be automatically enabled for application of the software by indicating on the configuration screen. On the configuration screen the user may also enable or disable one or more specific printers thus determining whether specific print jobs will receive application of the software.

In one preferred embodiment, various reports 400 are available upon user indication responding to the configuration prompt screen. If indicated at the time of configuration, report totals for all printers may be provided by the software if the user enables compilation of the required information. All compiled information may also be removed, at the user's option, upon re-configuration of the software. Whether the information is stored and the reports are available for local printers and/or network printers and/or shared local printers is also a user choice upon configuration of the logic programs. As indicated on the drawings 410, available recorded information for reports on all printers include:
paper expense per page,
ink expense per page,
ink expense per image, and
individual expense values for each enabled printer (available to an administrator only on a network system).

Information available in reports includes a breakdown of applications from which users have printed during the report period with a disclosure of the proportion of print jobs for each application. Also, the proportion of users that have taken advantage of the duplexing option, the proportion of users opting for black & white printing, and what print devices are most used, may all be specified as report items. These reports are also separately and individually available for each individually enabled printer if the reports are appropriately indicated on the configuration screen. A report indicating the overall effectiveness 420 of applying the software's logic programs is available as indicated on the configuration screen.

Accordingly the report feature may prove invaluable to those trying to understand the structure and nature of printing expenses, and may serve as a basis for reducing wasteful practices through user education. In a preferred embodiment the following reporting functionality features are available:
1. Statistics on how many pages have been printed by user, workgroup, the entire organization or any subset of users
2. Statistics on how many pages have been saved by user, workgroup, the entire organization or any subset of users
3. Statistics on how much money has been saved and spent by user, workgroup, the entire organization or any subset of users
4. Statistics on how much CO2 or Greenhouse Gas has been saved and spent by user, workgroup, the entire organization or any subset of users
5. Statistics on how many trees has been saved and spent by user, workgroup, the entire organization or any subset of users
6. Configurable per page cost statistics for each printer in the organization
7. Statistics on how many pages are printed in color vs. black and white, by user, workgroup, etc
8. Statistics on what percentage of pages printed were duplexed vs single sided, by user, workgroup, etc
9. Statistics on what applications users are printing from (e.g. Word, Excel, Outlook, Firefox), by user, workgroup, etc
10. Statistics on what time of day users are printing, by user, workgroup, etc
11. Statistics on what type of printers are being printed to (e.g. USB, Networked, Color, B&W, Multifunction), by user, workgroup, etc
12. Statistics on the average printed job size, by day, time, workgroup, user
13. Outlier statistics—how many users are printing more than one standard deviation from the norm and who are they
14. List of users that print the most, by workgroup, across the organization, by application type, in color, to a certain printer
15. List of workgroups that print the most
16. List of printers that get printed to the most/least
17. List of printers where the number of print jobs per month is increasing the most
18. List of users that print the most images
19. List of user that print the most coverage
20. List of pages printed by new users
21. Most printed documents by document title
22. Users with the biggest reduction in printing over a given period of time
23. Users with the greatest monetary savings over a given period of time
24. List of most recently added printers
25. List of most recently added users
   In one preferred embodiment, in which there is a server-based networked system with a system administrator who has access to the server, the system administrator has the following capabilities, using the software:
1. Ability to set pages printed quotas by user, workgroup, or organization.
2. Ability to set print options by user, workgroup, org (e.g. the accounting workgroup is only allowed to print in black and white).
3. Ability to set output printers by user, workgroup, org (e.g. finance cannot print to the expensive color laser printer)
4. Ability to restrict printing by time on a per user or workgroup basis (e.g. no one in accounting can print after 9 pm)
5. Ability to restrict printing by application on a user or workgroup level (no one in the organization is allowed to print from Firefox)
6. Ability to restrict printing by printer type on a user or workgroup level (no one in marketing can print to a USB printer)
7. Ability to message to people about their printing habits (“you printed 10% more this month than last”)
8. Ability to prevent users or workgroups from printing pages with images
9. Ability to prevent users or workgroups from printing pages over X % coverage
10. Ability to redirect a print job to a printer more suited to it (e.g. black and white jobs get redirected from an expensive color printer to an inexpensive black and white laser printer.)
11. Ability to set print default options such as, color, B&W, duplex, pages per sheet by originating application.
12. Ability to add metadata to a user, workgroup or printer

After configuration of the software's set of logic programs 430, a spooler program 440 capable of processing a computer application file received from the application program, readies the application file for the printer.

Any application file that is to be printed is translated into a CF file 450 regardless of which application program created the original file and which printer is to do the printing. In this manner, application programs have the CF file as a common target when translating their custom application file. Printer drivers can then be built to function with the CF file as a single type of data formatting. When the application file is formatted to the CF file it may be designated as an “enhanced meta file,” or “EMF.” The EMF has both raster information, in which each possible dot in an area is designated as being either black or white, and vector information, in which line segments are described by designating their endpoints, are used. Other common formats are possible, printer languages such as PCL, postscript and more recently the XML Paper Specification (XPS). Nevertheless, it may be noted that new systems for printing have been proposed including the XPS system, which may be introduced by Microsoft Corp. in 2007.

In the MAC OS X printing architecture, a Portable Document File (PDF), a common file format that was originally proprietary to Adobe Corp., is used as the CF file. A “job ticket,” which contains information on various print parameters, is created to accompany the data in the PDF document.

The CF file containing printer data sent to specified printers is filtered 460 by the software's configured program to determine whether each specified printer has been enabled during configuration. CF files sent to software enabled printers are diverted for logic analysis pursuant to the user's chosen configuration criteria.

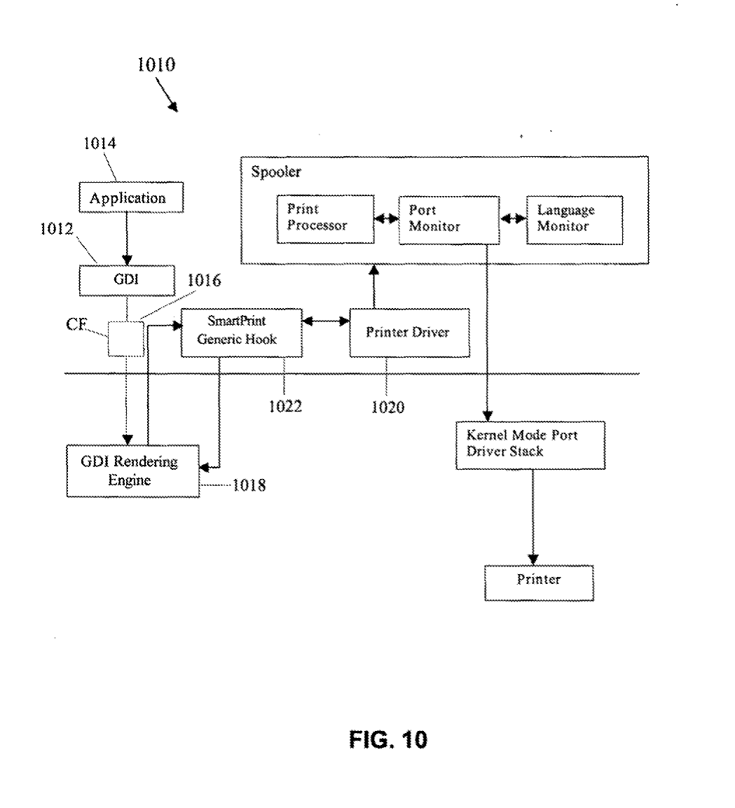

The diversion noted above could happen in any one of several different ways, depending on whether the computer system being used is a computer network or a single computer, connected to a single printer. Referring to FIG. 10, a system is shown which may be used for either the network or the single computer case. It is currently the case that most personal computer (PC) software suites, such as software suite 1010 host a graphics device interface (GDI) 1012, to which application programs 1014 send their data. The GDI creates a CF 1016, typically an EMF or a simple raster scan (dot/no dot) of the pages it receives. The CF is typically “read out” by a GDI rendering engine 1018 to the Original Equipment Manufacturer (OEM) Printer Graphics driver 1020. In the system established for this preferred embodiment, a Print Hook program 1018 is interposed to receive the CF read out and to analyze it. It sends the pages back to the GDI rendering engine to be stored for user review.

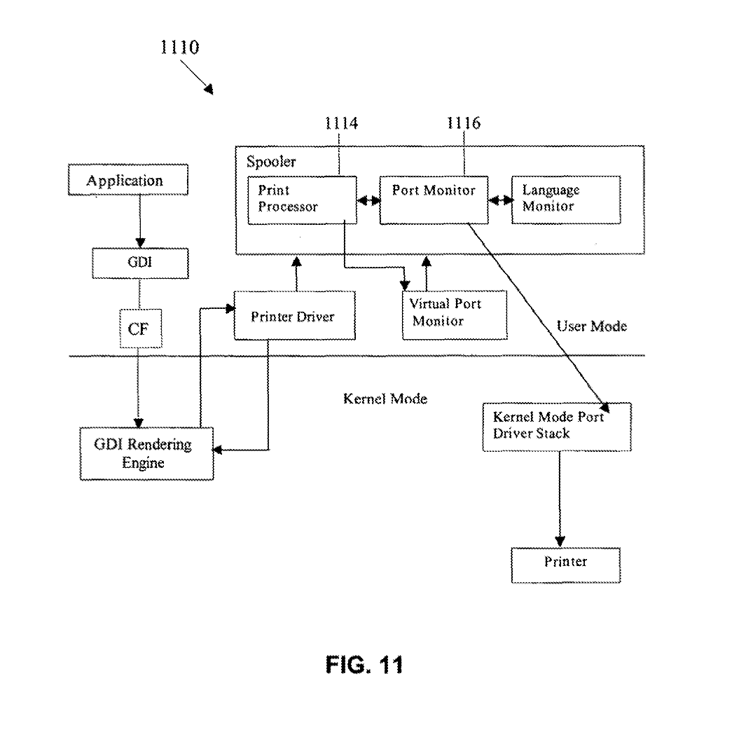

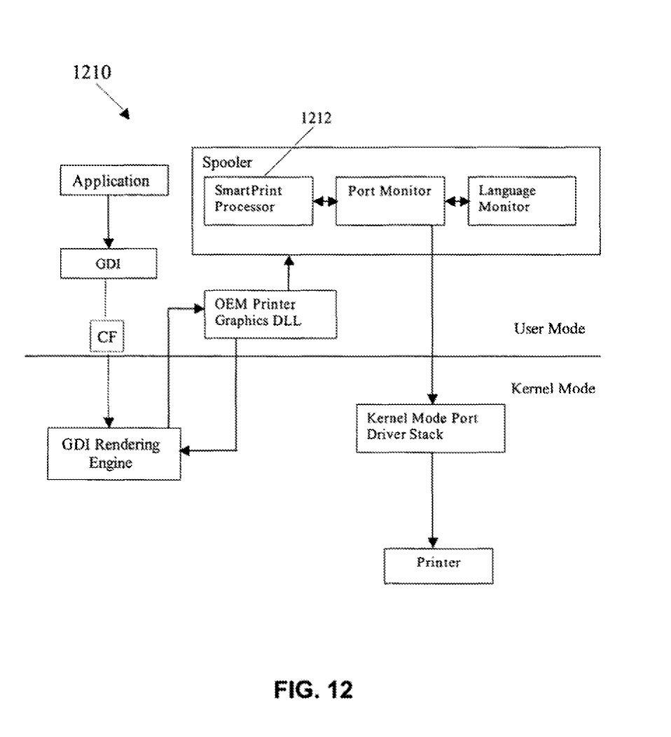

Referring to FIG. 11, in the same basic system 1110 as is shown for FIG. 10, a virtual port monitor (VPM) 1112 is interposed between the print processor 1114 and the actual port monitor 1116. VPM 1112 intercepts data from the print processor, analyzes it, and displays it to the user, before sending it to the actual port processor 1116 for printing. Referring to FIG. 12, in a single computer or peer-to-peer system 1210, the print monitor is replaced with a smart print monitor 1212, which intercepts the print data and analyzes it.

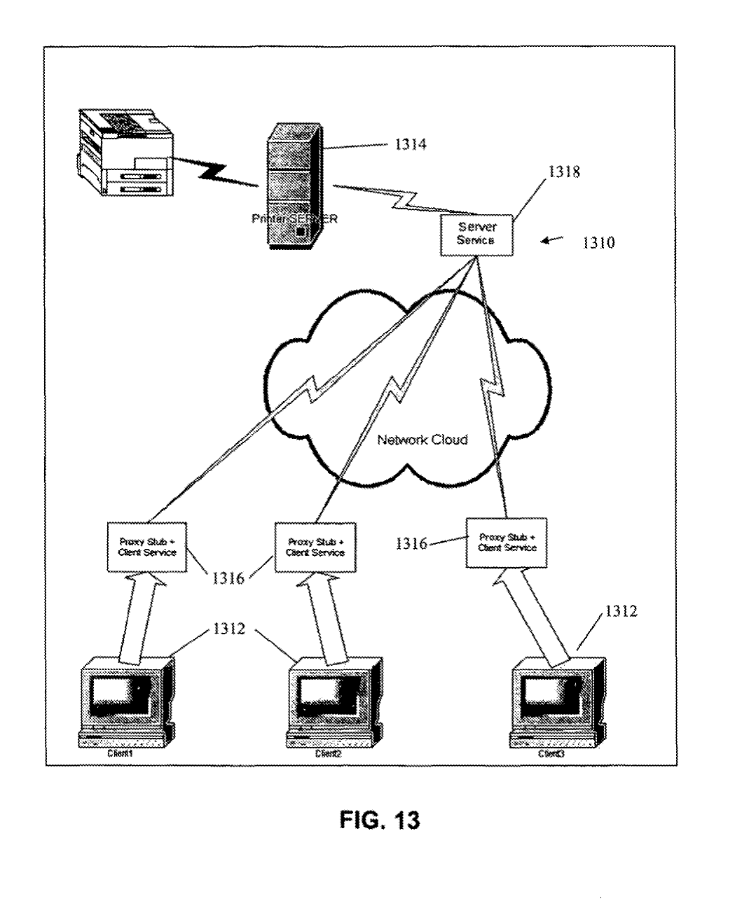

Finally, referring to FIG. 13, in a system 1310 in which client computers (clients) 1312 are connected to a server 1314, through which print jobs may be directed, each client has software in the form of a proxy stub 1316 adapted to permit it to send the user choices to the server, mated to server service software 1318 adapted to receive this information. In addition, client and server have software permitting the server to send the print coded jobs back to the client for user review.

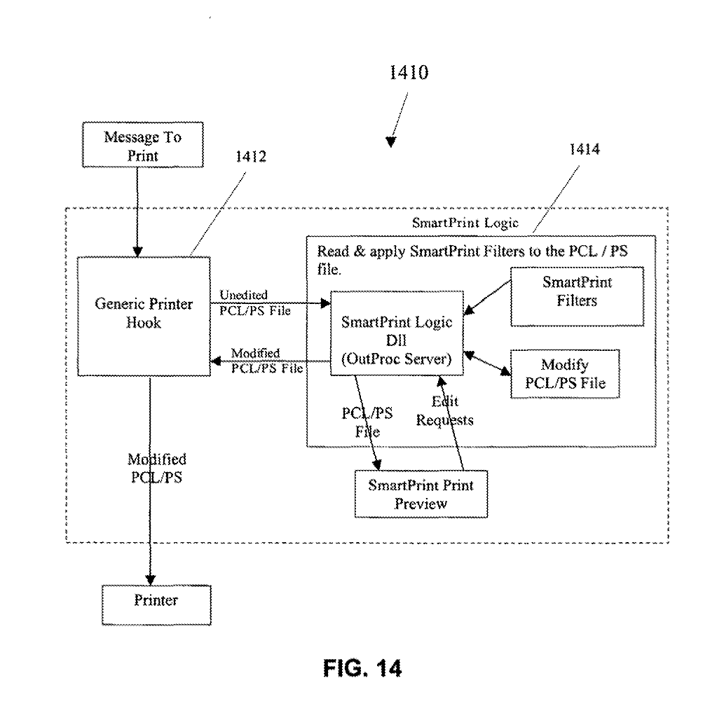

Referring to FIG. 14, regardless of the type of hook structure used, in a preferred embodiment system 1410, communications from the print hook 1412 to the analysis program 1414 are in printer language, typically a combination of printer control language (PCL), postscript (PS) and More recently XML Paper Specification (XPS).

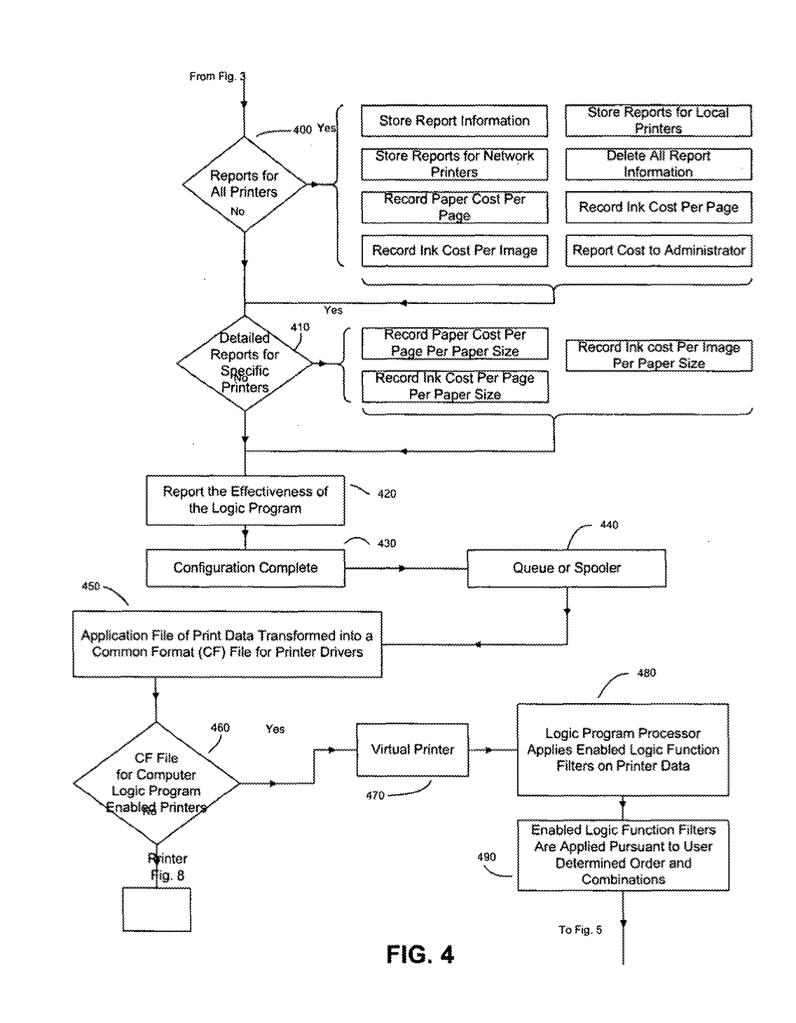

In one preferred embodiment (FIG. 4), a virtual printer 470, emulating a printer associated with the system, performs the logic analysis 480. Further filtering and processing of the CF file, explained below, is also performed by the virtual printer.

In one preferred embodiment, analysis program 480 performs a number of tests, designed to identify prospective waste. In one test a page is identified if the total amount of printing is below some threshold level, for example 5% of the total page area. This is a useful test not only because such pages in many instances will contain no useful information, but also because even if the information is useful, the user may wish to reformat the file, so that the information is shifted to another page. This may enhance the appearance of the final document, as well as saving paper. In a preferred embodiment, the printed area threshold is user selectable.

Another test is the unique printing test, wherein pages are identified if they have only printing which is existent on other pages. An otherwise blank page having line numbering and extensive header and/or footer information may, for example, evade the printed area test, but could be identified using this test. In a variant, the percentage of page area covered by unique printing is compared to a threshold. This test might catch the case in which the only item on a page, other than line numbering and header and footer data, was a page number. In yet another test, pages are identified if nothing, or a below threshold amount, is printed in the center-right portion of the page, that is the portion where unique information is typically contained, as header and footer information is placed at the top and bottom and line numbers are generally on the right. In one preferred embodiment the user is permitted to designate the area in which the lack of printing causes a page to be identified. In a preferred embodiment, this may be done by dragging the cursor diagonally, with the area being outlined for easy reference. More generally, the test can be considered to be the unique printing in a user defined area test, where if there was less than a threshold amount of printing in a user defined area, the page would be identified.

All of the above noted tests could also be performed specifically for color printing, as color printing may require special, more expensive ink. In these instances the user could be given a choice of: kill; print; print in black and white; or print, but kill identified color area. In another test, analysis is performed for the amount of ink needed to be used in each area of the page, with a page having an area using above a threshold amount of ink being identified.

An additional feature allows the user to determine the order of application of the configured logic criteria. This feature allows the CF file to be filtered in a user specified order 490. Further application of this feature allows the configured logic criteria to be applied after inclusion or exclusion of a page and allows the configured logic criteria to be applied in combination. An example of logic criteria applied after exclusion of a page could occur when the logic program or user removes an image in a page and the feature is applied to identify a page with a less than specified number of text lines. An example of logic criteria applied in combination could occur if a page has less than a specified number of text lines but more than a specified percentage of text area. This page may or may not be considered waste, depending upon a user's determination or configuration criteria.

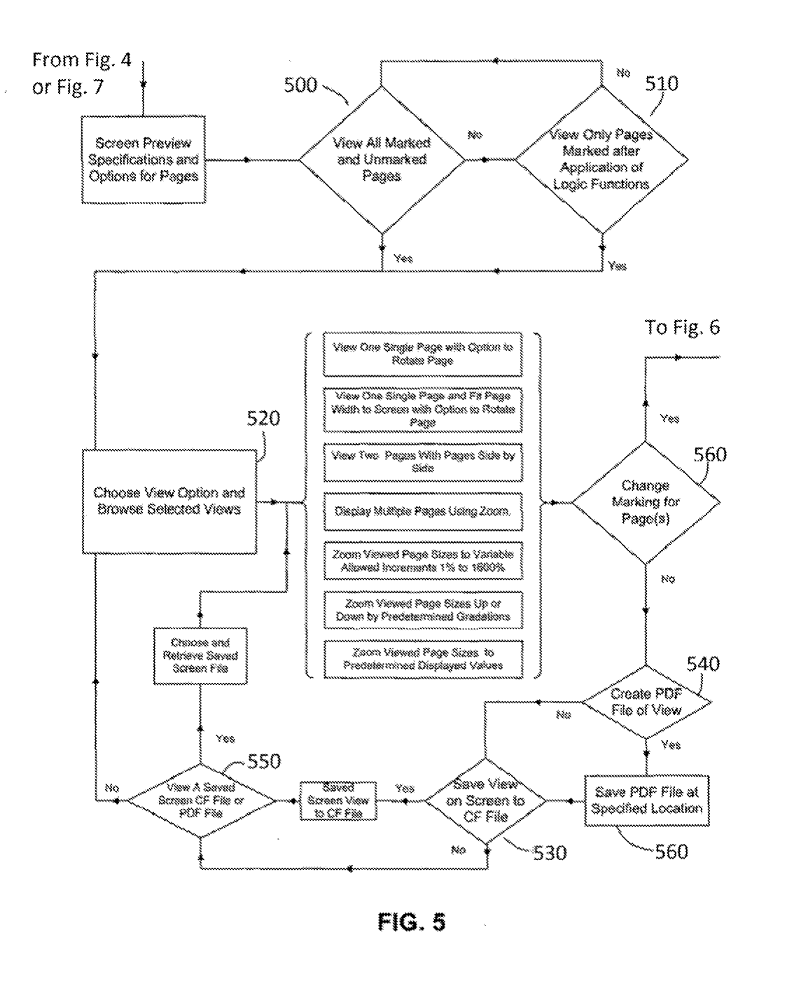

Following the software's logic analysis pursuant to the user's prior selected configuration criteria, the software provides screen displays pursuant to the user's selection. Prior to printing, a user may select to preview all pages of a print job including pages marked for removal 500(FIG. 5), or a user may select to preview only the marked pages intended for removal 510. Pages selected for display may be displayed in several different arrangements 520 pursuant to further selections by the viewer. These arrangements as indicated on the drawings 520 include:
viewing a single page,
viewing two pages side by side,
viewing multiple pages,
viewing pages at variable enlargement values from 1% to 1600%,
viewing pages at predetermined incremental enlargement values, and
viewing pages in a rotated manner.
   A browser allows the user to move among pages and views making and changing view selections as necessary and desired.

At the user option, any view may be saved 530 in the CF file. Further, any view screen may be converted into a PDF 540 document and saved 560. Saved views may be returned to the screen for further user analysis 550, including revision to the page removal or inclusion decision. Saved PDF documents may also be returned to the screen for further user analysis, including revision to the page removal or inclusion decision. If a displayed preview screen is closed the prospective print job is cancelled, and the CF file deleted.

Screens displayed on the preview screen are first marked pursuant to the configured software. Pages identified by the software to be included in the print job are not marked. Pages identified by the software to be removed from the print job are shaded in transparent red. The page markings with the include-remove decision, as first displayed, may also be changed 560 at the discretion of the user. Pages originally intended by the software for removal but changed by the user for inclusion in the print job are shaded in transparent green.

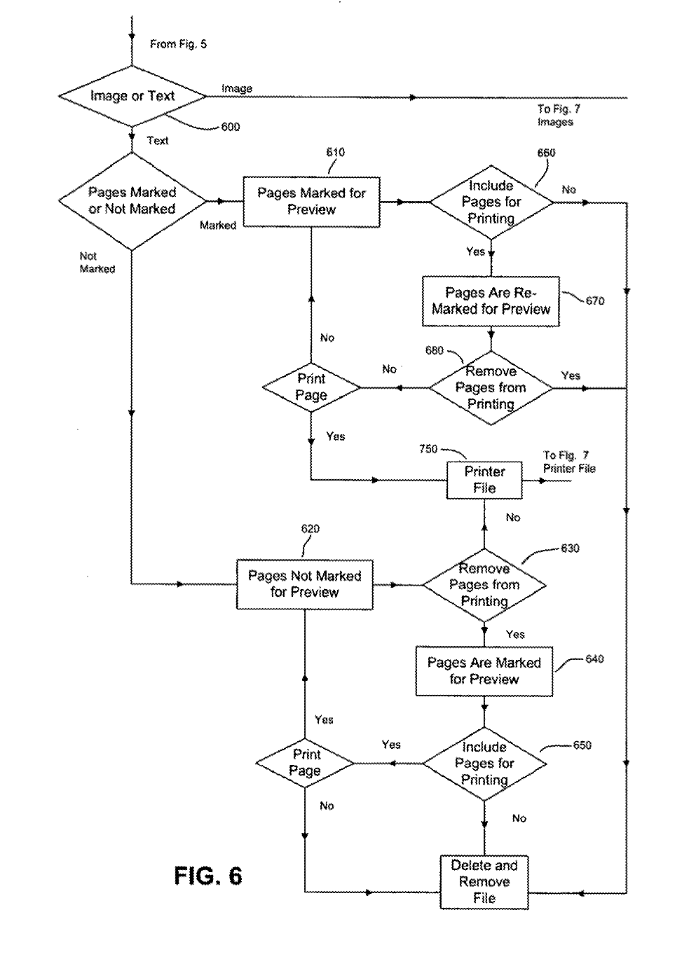

Pages previewed are also marked differently depending upon whether the pages are displaying text or images 600 (FIG. 6). Pages displaying text are either marked for deletion 610 from the print file or are not marked 620. Pages containing no markings, intended for inclusion in the print file for printing, may at the discretion of the user, be removed from the print file 630. When the previewed page has a user included deletion marking 640, the user may subsequently choose to include the page for printing 650. At the discretion of the user, the user may make as many changes as necessary, from remove to include and from include to remove, while the page is on the preview display. The user can also eliminate a single item from a page, such as a single image or line of text, while printing the remainder of the page.

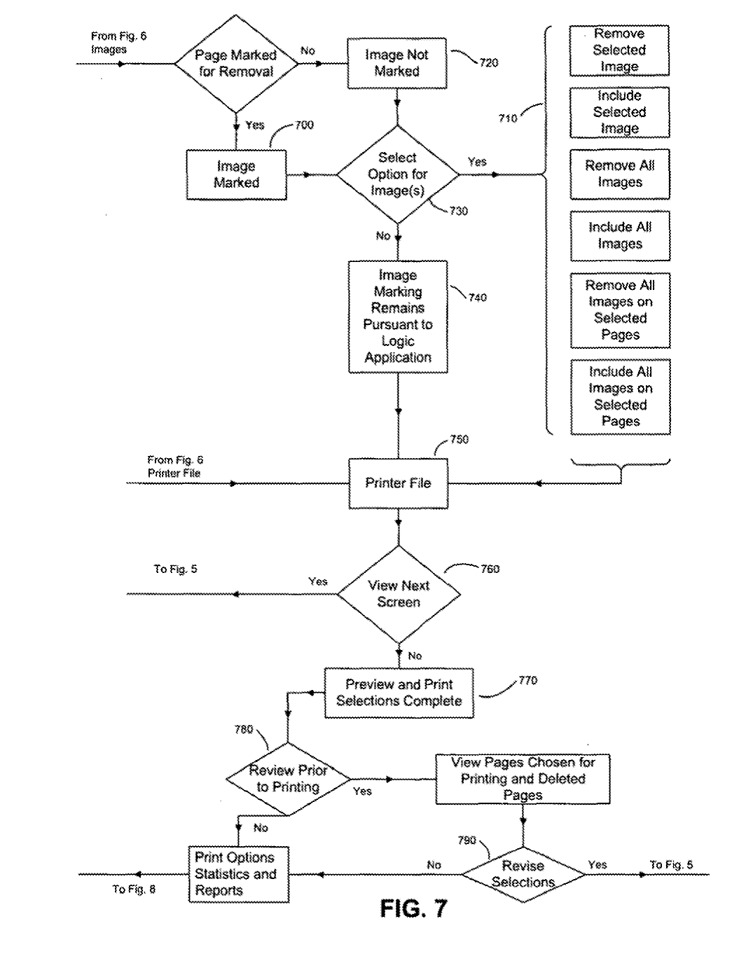

Displayed pages containing markings indicating a page has been identified by the software for removal from the print job may be included in the print job 660 at the discretion of the user. When this previously marked page has been included in the printer job, the page has the transparent green displayed 670 indicating the page was previously chosen by the software for removal from printing. These special display marked pages may also subsequently be removed from the printer file 680 at the discretion of the user. When the user has completed making changes to the previewed page or pages, the CF file of the text print job is sent to the printer file 750 (FIG. 7).

Displayed images are also marked, similar to text markings, for removal 700 from the print job pursuant to the user configured software. Software-identified images available for removal have an orange opaque border, or in an alternative preferred embodiment, are rendered translucent. If the user also chooses to remove these pages, the user will mark these pages with a red opaque border. At the discretion of the user 730, these displayed images may then be subject to a menu of choices 710 allowing the user to modify the marking and print job image removal determination. Displayed images may also be identified for inclusion in the print job 720. These images, at the discretion of the user may also then be subject to a menu of choices 710 allowing the user to modify the identification and print job image inclusion decision. The menu of allowed choices as also listed on the drawings 710 are:
remove selected images,
include selected images,
remove all images,
include all images including images indicated for removal from the print job,
remove all images in selected pages, and
include all images in selected pages including images indicated for removal from the print job.

If the user decides not to change the image identification or image marking 740, the CF file of the image will be sent to the printer file 750.

Following the user's discretion to send pages to the printer file, the user's decision 760 is made whether to view the next screen or continue in the print job sequence. Continuing in the print job sequence, the page and image, removal and inclusion decisions, remain established pursuant to the software's logic and pursuant to the user's determinations following the user's preview of displayed pages. Preview and print selections are, at this point in the sequence, complete 770.

Prior to printing the print job, however, the user is provided another opportunity to review the entire print job 780. If the user decides to review the entire print job and revise the established selections 790, the print job removal and inclusion selection process is repeated for previewed display screens selected by the user. If the user decides not to review the established print job, the print job is sent to the printer allowing the user several printing options. In a preferred embodiment, these printing options 800 as detailed on the drawings are:
print only the printer file included pages and remove the pages considered wasteful to print pursuant to the software's logic and the user's discretion,
print all pages as originally sent from the microprocessor computer to the printer,
print only selected pages as determined by the user pursuant to pages displayed on the preview screen,
print text only, and
print images only.

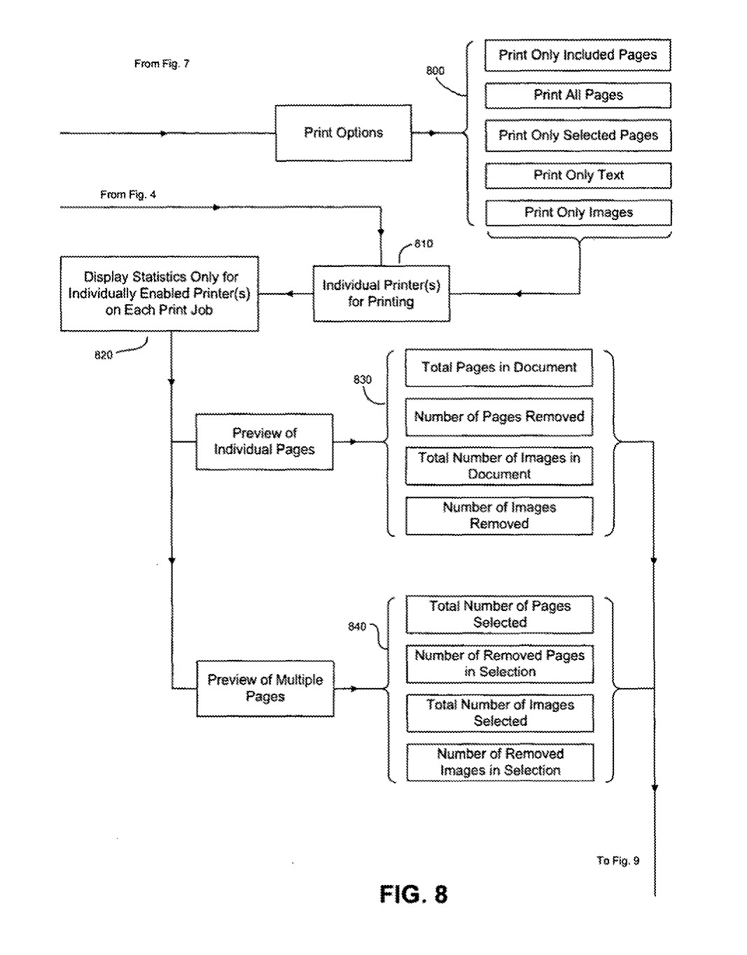

When the print job arrives at each printer 810 (FIG. 8) designated by the user to receive the CF file, the print job will be printed. All required print jobs will be printed on each printer designated by the user. All of the user designated printers, for a specific print job, may not have been enabled. Because specific printers are not enabled, the user, on these printers, will not receive the benefit of reducing paper and ink usage. Also, the user will not, on these printers, be provided statistics through printed reports and displays 820, with respect to printers not enabled. For enabled printers, the following statistics are displayed 830 if the user has chosen to view single pages 520 (FIG. 5) when viewing the results of the configured software:
display total number of pages in document,
display the number of pages removed,
display the total number of images in the document, and
display the number of images removed.

For enabled printers, the following statistics are displayed 840 (FIG. 8) if the user has chosen to view multiple pages 520 (FIG. 5) when viewing the results of the configured software:
display total number of pages selected,
display the number of pages removed in the selection,
display the total number of images in the pages selected, and
display the number of images removed in the pages selected.

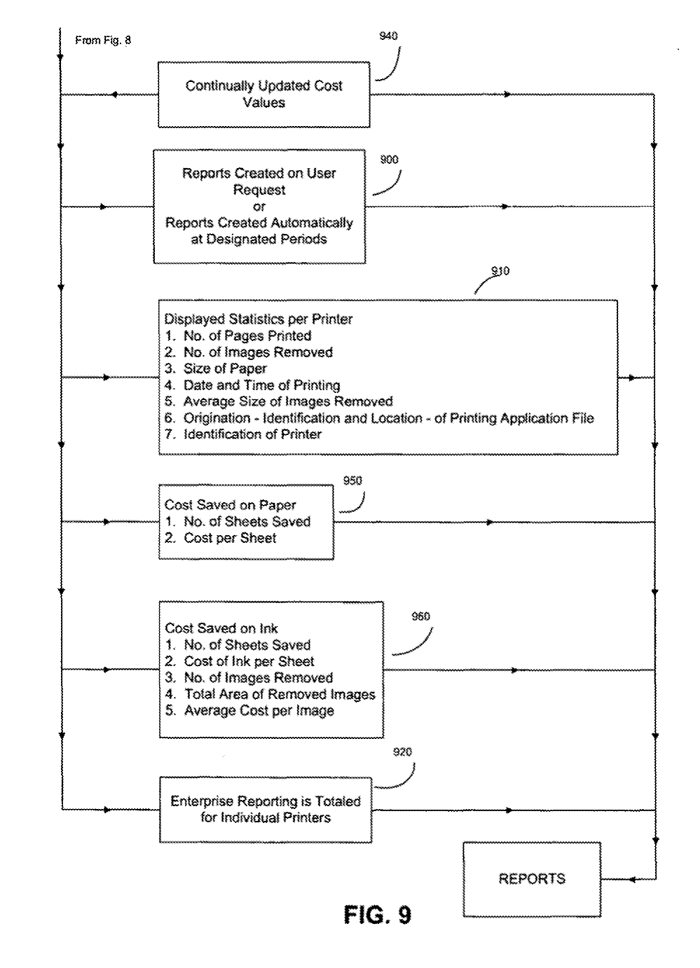

Printed reports detailing saved printed expenses are available in varying degrees of detail and available at user determined choice of times 900 (FIG. 9). Reports can be created any time upon a user request. These reports can cover any desired time period. Reports can also be created at desired intervals including daily, weekly, monthly or yearly. Reports are divided into two general groups. The first group is individual printer reporting, compiled from statistics logged on each printer 910. The second group is network wide reporting 920 covering all print jobs given to a network of printers and the totals from all print jobs given to individually shared printers.

For an accurate reporting of the expenses saved, each relevant cost must be updated 940 by the user when there is a change in that cost. Costs reported by the user are paper cost per page, ink cost per page, and ink cost per image. The administrator may override the user entered cost and apply different cost values for any or all printers. All user entered cost values and all administrator entered values are available for display only to the administrator.

If more detailed reports are preferred, a user may enter costs necessary for compilation of these more detailed reports. These costs are paper cost per page per paper size (This is the cost of paper per a unit of paper area.), ink cost per page per paper size (This is the cost of ink per a unit of paper area.), and ink cost per image per paper size (This is the ink cost of images per unit of paper area.)

Statistics calculated by the software are logged at the printer level and are available for reports. These statistics as also listed on the drawings 910 (FIG. 9) are:
number of pages printed,
number of pages removed,
size of paper for the print job,
date and time of print job,
average size of images removed
origination, including identification and location, of the CF file used for printing the print job, and
identification of the printer.

Based upon these statistics and at the user's request regarding the time, reports are provided displaying the expenses saved on paper 950 and the expenses saved on ink. Displayed paper saving expenses, as also listed on the drawings 950, are:

the number of sheets saved, and

the cost per sheet.

Displayed ink saving expenses, as also listed on the drawings 960, are:

the number of sheets saved,

cost of ink per page,

the number of images removed,

the total area of images removed, and

the average cost per image.

When paper and ink expense savings are displayed, the user is able to determine how the software calculated each expense saving. A display is available detailing all figures used to arrive at an expense saving and the relevant calculations performed. All displayed individual printer reports; including displayed statistics, displayed paper and ink saved, and displayed calculations; can be saved and retrieved at any future time for viewing and analysis.

Network information regarding paper saved and ink saved for specific groups of printers is available. Network information is compiled from data collected and costs provided for each individual printer in the network. Statistics logged and compiled for each individual printer are used for calculating the total paper saved and ink saved for all printers in the network. Compiled network reports for paper and ink saved are displayed in the same manner and provide the same information as reports for individual printers except the information provided is totaled from all printers in the network. All displayed network reports can be saved and retrieved at any future time for viewing and analysis.

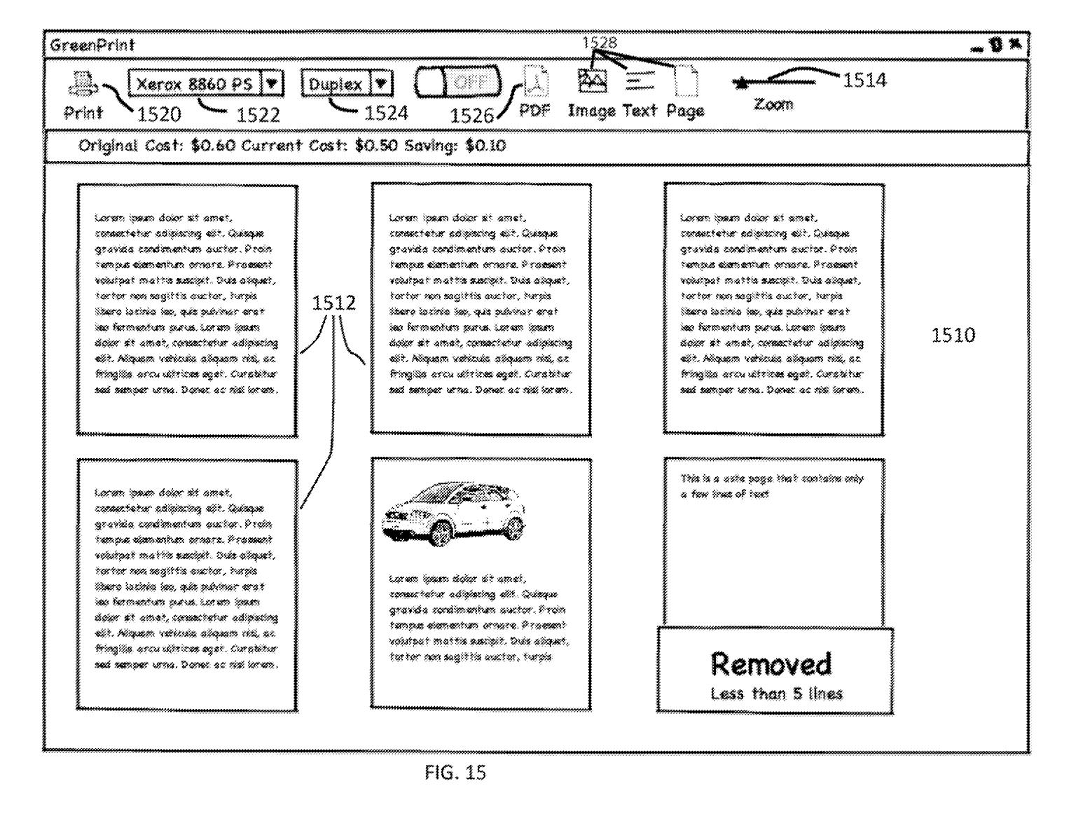

Referring to FIG. 15, a computer screen 1510 shows pages 1512 in a print queue displayed according to the present invention. After the software of the present invention is installed on a computer, this is the default display after someone has commanded the system to print a six page document. For a longer print queue, a scroll bar appears on the right of the screen. A page size zoom bar 1514 appears at the top of the screen. Although for print jobs of the length shown page depiction size is not a major issue, for longer print job, there is a trade-off between the number of pages displayed and the size of the displayed page depictions. At the smallest size page depiction permitted in a preferred embodiment, each page depiction is about the size of thumbnail, or about 10² cm (roughly 1″ by ½″) on a 17″ diagonal display screen. The larger the page depiction, the easier it is for a user to make a determination concerning whether or not to kill a page from the print queue, but the more scrolling he must do to see the entire document. Accordingly, page size zoom bar 1514 plays a valuable function in ease of use, by permitting the user to change page size until he can get a good enough idea whether or not the page is worth printing.

In an alternative preferred embodiment the page depiction size is set by an algorithm and is related to document length, with a document of more than 30 pages resulting in page depiction sizes of about 10 cm², and a 1 page document resulting in a page depiction size that fills the computer screen from top to bottom. In an another alternative preferred embodiment the user chooses the minimum page size through a dialogue box, and this becomes the default until the user makes a new choice.

At the top of the screen, just under the “GreenPrint” banner are a number of buttons. The print button 1520 permits the user to command the system to print. The printer menu bar 1522 permits printer selection.

These buttons are transparent in the sense that they offer the user the same choices the user would have without the installation of the software of the present invention. The duplex menu 1524 permits the user to choose two-sided printing, thereby saving on paper. If duplex, or two-sided printing is chosen, instructions are given on the screen so that the user knows how to insert the paper that has been “one sided printed” at the half-way done point. The menu also gives the choice of “on long-edge” or “on short-edge” for landscape printing.

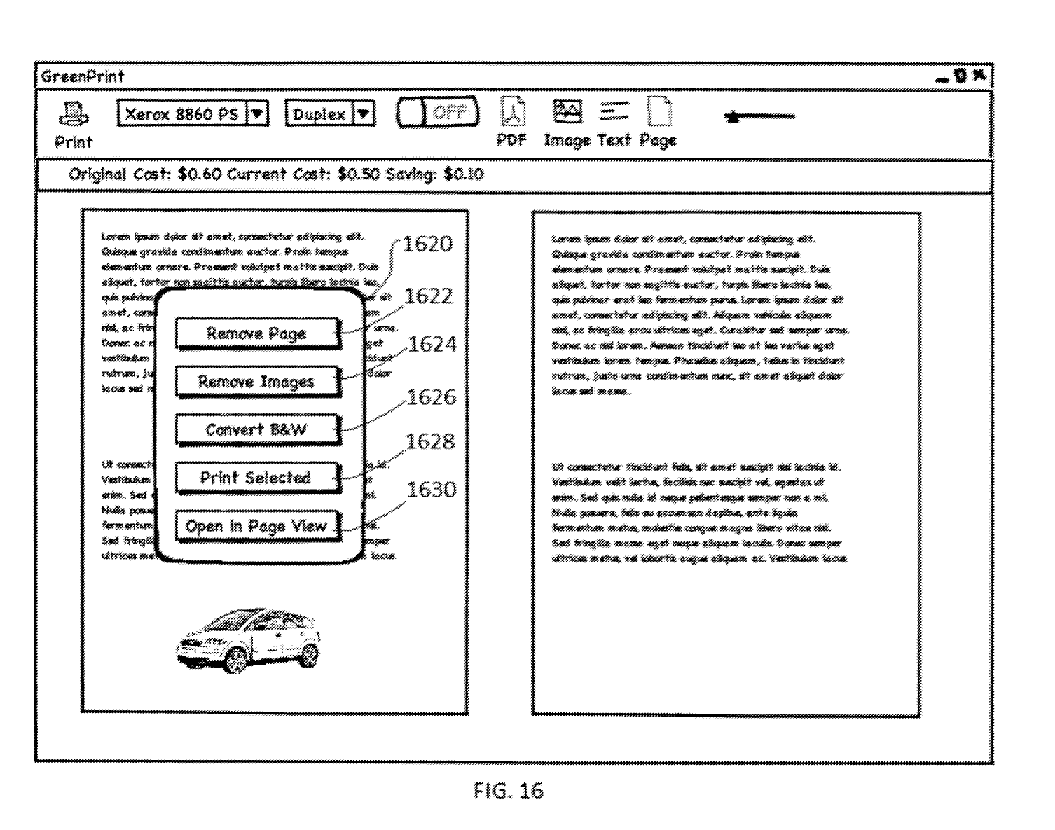

To the right of the duplex menu is the PDF button 1526, which if activated causes a PDF document to be made of the document being displayed. The image, text and page buttons 1528 perform the same functions as those described for the similarly named buttons, in the discussion of the right-click menu on FIG. 16.

FIG. 16 shows a computer display screen, similar to that of FIG. 15 except for that only two pages are displayed, and the user has “right-clicked” on the leftmost of the two. The term “right-clicked” will be familiar to any user of a standard personal computer, to mean guiding the cursor (typically using the mouse) over the area of interest and pressing the rightmost of the two main mouse buttons. In this instance a menu 1620 appears, superimposed over the page of interest, and a set of options are provided to the user, any one of which may be realized with a left-click (the same as a right-click but with the leftmost of the two main mouse buttons). The topmost option, to “remove page” 1622 may be fairly self-explanatory to many readers. If this choice is made, the page is not printed out in the subsequent printing. Below this choice is “remove images” 1624, which will remove any images on the page from the subsequent printing. This may be a particularly useful option when printing out the text of a webpage where the images are for advertisements. The third choice, “convert B&W” 1626 will cause the page to be printed in black and white, thereby saving the more expensive color ink. The fourth option “print selected” 1628, would cause the print job to be limited to previously selected material. Those familiar with the use of personal computers will already be familiar with the process of selecting text and other features in a document by holding down the shift key and moving the cursor, causing the selected items to be shown in reverse image. Finally, “open in page view” 1630, if selected changes the display to a set of thumbnails on the left side of the screen, with full page displays that may be scrolled through on the right.

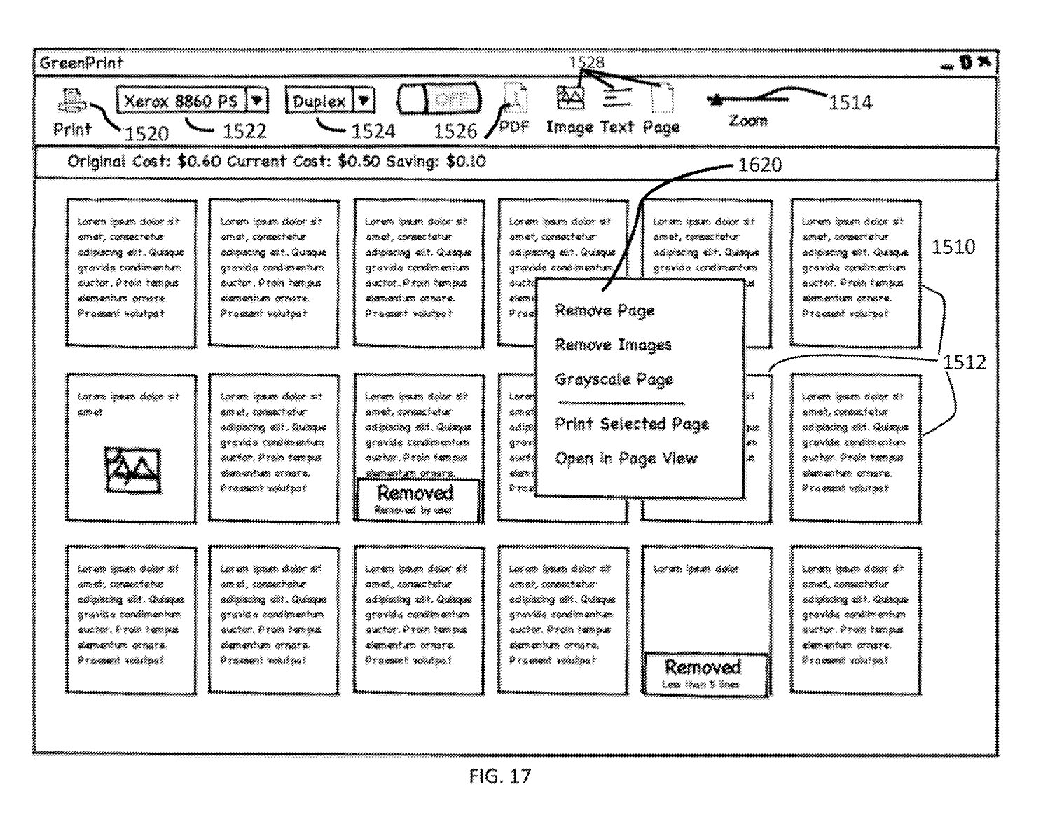

In a preferred embodiment, at most 10 pages are displayed on a computer screen. In this embodiment, in the case of a lengthy document the user can page through the print job 10 pages at a time. In the preferred embodiment shown in FIG. 17, however, twenty-eight or more pages may be displayed. There is a natural trade-off between page size and number of pages displayed. In the preferred embodiment shown it is easy to see many pages at once and then to use the zoom bar 1514 to more closely examine a few pages at once, in order to make a more well-informed choice as to whether to remove one or more of the pages from the print queue.

While a number of exemplary aspects and embodiments have been discussed above, those possessed of skill in the art will recognize certain modifications, permutations, additions and sub-combinations thereof. In particular, skilled persons will recognize that systems could be built without each one of the characteristics described above. For example, in an alternative preferred embodiment it is not possible to print only text or print only images. It is therefore intended that the following appended claims and claims hereafter introduced are interpreted to include all such modifications, permutations, additions and sub-combinations as are within their true spirit and scope.

1. A computer readable medium having a computer program that when installed on a computer having applications which can be commanded to print and which place pages in a print queue, causes a print command to result in a display of pages and which permits a user to remove any of said displayed pages from said print queue by a sequence of no more than two mouse clicks.

2. The medium of claim 1, wherein said sequence of mouse clicks is comprised of a single mouse click only, over said displayed page to be removed.

3. The medium of claim 1, wherein said sequence of mouse clicks includes a right mouse click over said page, causing a menu to appear, followed by a selection of a “remove page” option from a click menu, by a left mouse click.

4. The medium of claim 3, wherein said sequence of clicks is comprised of a only a single mouse click.

5. The medium of claim 3, wherein said menu includes an entry for printing said page with images removed, and by left clicking on said entry for removing images, said page is printed without images.

6. The medium of claim 3, wherein said menu includes an entry for printing said page with using black ink only.

7. The medium of claim 1, wherein after a user has removed a page from said print queue, said page is displayed with an indication that it will not be printed.

8. The medium of claim 1, wherein said computer program makes an assessment of value for each page and removes each page having a value assessment below a threshold from said print queue and wherein said pages tentatively removed from said print queue are displayed with an indication that they will not be printed.

9. The medium of claim 1, wherein any page removed from said print queue may be returned to said print queue by way of a sequence of mouse clicks.

10. A computer readable medium having a computer program that when installed, on a computer having applications and having a display screen, responds to a command to print a set of pages by displaying a subset of said pages at a user selectable page display size, said subset comprising the number of pages that will fit on said display screen at said user selectable display size.

11. The medium of claim 10 wherein said computer program causes a page display size adjustment slider to be displayed along with said display of pages, and wherein a user can move said slider with a mouse, thereby causing said adjustment to said page display size.

12. The medium of claim 10, wherein a user may prevent a page from said set of pages from being printed by a performing a series of mouse clicks.

13. The medium of claim 10 wherein said subset comprises all of said pages in said set.

14. A computer, comprising:
(a) computer readable media having computer programs that can be user commanded to cause a print queue to be sent to a printer;
(b) computer readable media having a computer program which, when a user commands a print queue be sent to a printer, causes a display of pages in said print queue and permitting a user to remove a page from said print queue by a sequence of mouse clicks.

15. The computer of claim 14, wherein said sequence of mouse clicks is comprised of a single mouse click only, over said displayed page to be removed.

16. The computer of claim 14, wherein said menu includes an entry for printing said page with images removed, and by left clicking on said entry for removing images, said page is printed without images.

17. The computer of claim 14, wherein said sequence of mouse clicks includes a right mouse click over said page, causing a menu to appear, followed by a selection of a “remove page” option from a click menu, by a left mouse click.

18. The computer of claim 17, wherein said menu includes an entry for printing said page with using black ink only.

19. The computer of claim 14, wherein after a user has removed a page from said print queue, said page is displayed with an indication that it will not be printed.

20. The computer of claim 14, wherein said computer program makes an assessment of value for each page and removes each page having a value assessment below a threshold from said print queue and wherein said pages tentatively removed from said print queue are displayed with an indication that they will not be printed.

21. The computer of claim 14, wherein any page removed from said print queue may be returned to said print queue by way of a sequence of mouse clicks.

22. Computer readable media, having a computer program that when installed on a computer network having printers permits network users to display pages to be printed from user applications, and further permits the generation of reports detailing use of said network printers.

23. The computer readable media of claim 22 wherein one of said reports lists number of pages printed for each application program permitting printouts.

24. The computer readable media of claim 22 wherein one of said reports shows how many pages have been printed by each user, each workgroup and the entire organization.

25. The computer readable media of claim 22 wherein one of said reports lists how many pages have been saved by each user, each workgroup and the entire organization.

26. Computer readable media, having a computer program that when installed on a computer network having printers permits a network administrator to selectively restrict printer use.

27. The media of claim 26, permitting a network administrator to set pages printed quotas applying to groups selected from a set of choices including user, workgroup and by user, workgroup, and organization.

28. The media of claim 26, permitting a network administrator to set print options applying to groups selected from a set of choices including user, workgroup and organization.
